(19) United States
(12) Patent Application Publication
(10) Pub. No.: US 2003/0172275 A1
(43) Pub. Date: Sep. 11, 2003

(54) Real-time blind watermarking method using quantization

(76) Inventors: Seung Wook Lee, Pusan (KR); Jin Ho Kim, Taejon (KR); Won Young Yoo, Jeonju (KR); Young Ho Suh, Taejon (KR)

Correspondence Address: Jacobson Holman, 400 Seventh Street, N.W., Washington, DC, 20004-2218, US

(21) Appl. No.: 10/150,061

(22) Filed: May 20, 2002

(30) Foreign Application Priority Data
Mar. 11, 2002 (KR) 2002-12901

(51) Int. Cl. H04L 9/00

(52) U.S. Cl. 713/176

(57) ABSTRACT

The present invention relates to a protection of copyrights of digital data, and more particularly, to a real-time blind watermarking method using quantization, in which a watermark information for representing ownership is embedded in a digital image, video or the like so as not to be visually or aurally discriminated and is extracted after various attacks such as edit or the like, and which can be used in all compression ways. The real-time video watermarking system is a blind method and is simple. In order to perform DCT with respect to an original frame and enhance the robustness, the watermark is embedded in a low frequency component. Further, since the DCT is not performed with respect to all blocks, the invention has a rapid operation speed regardless of the size of the video frame. Furthermore, in extracting the embedded watermark and confirming the extracted watermark, the interference phenomenon between the host signal and the watermark signal is removed to thereby enhance the extracting performance. Moreover, since the watermark is embedded and extracted not in the compression stream but in non-compressed row frame, the invention can be used in all compression ways, i.e., has a very wide usage range.

### BACKGROUND OF THE INVENTION

1. Field of the Invention

The present invention relates to copyrights protection of digital data, and more particularly, to a real-time blind watermarking method using quantization, in which a watermark information for representing ownership is embedded in a digital image, video or the like so as not to be visually or aurally discriminated by human being and can be detected even after various attacks such as edit or the like, and which can be used in all compression ways.

2. Description of the Related Art

Due to the remarkable developments in the information processing system and the network infra, usage of the digital media increases abruptly. Production of multimedia data, distribution, processing and so on are being performed under a digital format. Digital media have various advantages compared with analog media. For instance, there is the media quality. Digital media are more definitive in the quality thereof than analog media, and they can be copied even without degeneration of the picture quality. These characteristics of digital media open various new possibilities. For instance, since it is possible to correctly know a pixel value in the digital media, the media can be freely transformed. This circumstance, however, causes a new problem, such as protection of copyrights. It is difficult to manage copyrights that can be illegally copied, and it is very difficult to manage copyrights that can be illegally transformed.

To this end, there was proposed a technology called DRM (Digital Rights Management). DRM means a series of technologies for protection, security and management of digital contents, i.e., technologies for prohibiting an illegal usage of distribution digital contents, and substantially protecting and managing rights and interests of related copyright holders, license owners and distributors, which are generated by usage of the digital contents.

For this purposes, there are needed various main technologies. Among the main technologies, watermarking technology is necessary for the protection of the copyrights. Upon packaging digital contents using the DRM technology, a watermarked content should be packaged. To this end, the watermarking technology is first needed so as to enable to manage the digital copyrights.

Watermarking technology is a technology for protecting original copyrights by extracting an ownership information that cannot be visually or aurally discriminated from digital contents containing the ownership information, such as image, video, audio and the like when copyright disputes are generated. For this purpose, there are requested several conditions.

First is the invisibility of the watermark, i.e., the embedment of the watermark should not cause the quality of an original image to be lowered, and even though the quality lowering is caused, it should not be visually detected.

Second is the robustness in which the watermark that is the ownership information of digital data can be detected even after various attacks. Embedded watermark should be robust so that it can be detected against various accidental data transformations that are generated during data transmission, or various intentional attacks for deleting the embedded watermark.

There are various attack methods to digital data, for instance, lossy compression technology such as JPEG, image blurring, sharpening, analog/digital conversion, digital/analog conversion and the like, which are all accidental attacks.

There are intentional attacks, such as distortion attach, presentation attack, mosaic attack, protocol attack, etc.

Third is the unambiguity of the watermark, which indicates the property in which the ownership of an embedded watermark is correctly discriminated. In other words, there should not occur a problem mistaken as if non-embedded watermark is embedded or vice verse.

Last is the security of the embedded watermark, which should depend not on the security of the algorithm but on the security of the secret key.

The conventional blind watermarking method includes a method based on the similarity, an echo-hiding method that is frequently used in the audio watermarking, a patchwork method using the sample expansion, which is mainly used in the image watermarking.

However, the conventional methods have a relatively high extraction error due to an interference phenomenon between the host signal and the watermark. Recently, there are frequently proposed methods based on the result of Costa. These methods decrease the interference between the host signal and the watermark to a considerable degree.

Meanwhile, a prior paper, IEEE Trans. On Info. Theory, Vol. 47 No. 4, pp 1423-1443, May 2001, “Quantization index modulation: a class of provably good methods for digital watermarking and information embedding” discloses a method for obtaining maximum information rate, minimum distortion and maximum robustness upon embedding information under a given white noise, which correspond to a method for embedding maximum payload with the maximum robustness when reviewed in terms of the watermarking system.

The constitution is divided into a portion for making a given original signal in a vector format, a cosine-conversion portion and a portion for quantizing the signal using a quantizer varied with the number of messages. The watermark is extracted by calculating which quantizer quantizes a given value made in a similar vector format. The aforementioned paper has an effect in which the payload can be mostly embedded theoretically in case that white noise is added.

Further, Korean Patent registration No. 10-2001-0025383 entitled “Real-time MPEG watermark embedding method and detection using block unit quantization on MPEG video bits stream”, discloses an embedment of the watermark in which a video frame is divided into 8×8 blocks for the protection of the copyrights, the DCT is performed, and the adaptive quantization is performed to map a DC value into two or three binary codes. The embedding method includes the steps of demultiplexing MPEG bits streams to decode a video; and extracting a frame to embed a watermark and performing DCT of the extracted frame into 8×8 blocks. This value is quantized using the adaptive quantization, the quantized value is mapped by a binary code having a DC value, and the mapped value is compared with a watermark sequence. At this time, if the watermark bit equals to a bit of the DC value, the DC value remains without being changed, otherwise the DC value is changed.

Since the watermark is embedded in the DC portion, the above method may have a high robustness if a visual degeneration can be avoided.

The prior Korean Patent introduced the concept of the adaptive quantization in order to reduce the degeneration of the video due to the insertion of the watermark, and enables to protect the copyrights by embedding or extracting the watermark in real-time by the blind method.

However, the aforementioned patchwork method, echo hiding method, etc., do not solve the basic problem like the interference between the host signal and the watermark signal. Further, since the video signal has a considerable amount of data, the algorithm should be simple in order to real-time process the video. But, there is not yet proposed a method for embedding the watermark having the robustness.

Furthermore, it can be thought that the watermark information should be embedded in LSB (Least Significant Bit) in a spatial domain so as to embed and extract the watermark at the fastest speed, but it causes a problem in the robustness. Accordingly, the method for embedding the watermark in the spatial domain has a problem in that the method is not robust against various attacks such as edit or the like.

### SUMMARY OF THE INVENTION

Accordingly the present invention has been devised to solve the foregoing problems of the prior art, and it is an object of the invention to provide a robust real-time watermarking embedding and extraction confirming method so that the watermark for protecting copyrights of digital data is not visually or aurally discriminated by human being and is detected even after various attacks such as a picture edit or the like.

A real-time video watermarking system of the present invention is a blind method and is simple.

In order to embed a strong watermark that is endurable against an attack such as edit or the like, the watermark is embedded in a frequency domain using the DCT (Discrete Cosine Transform). An arbitrary block is set on an original frame, the DCT is performed with respect to 8×8 pixels block, and the watermark is embedded in a low frequency component in order to enhance the robustness. Further, since the DCT is not performed with respect to all blocks, the invention has a rapid operation speed regardless of the size of the video frame.

Furthermore, extracting the embedded watermark and confirming the extracted watermark, are carried out by which a quantized signal, i.e., a center-moved signal calculated using an original signal is removed from the watermarked signal, to thereby remove the interference phenomenon between the host signal and the watermark signal. Through theses procedures, it becomes possible to enhance the extracting performance of the watermark.

As described above, the invention is to embed and extract the watermark for protecting the copyrights of digital data, and it is an object of the invention to provide a real-time blind watermarking method.

To accomplish the above object, there is provided a real-time blind watermarking method using a quantization in embedding a watermark for protecting a copyright of a digital data including an image or a video. The method comprises the steps of: dividing a plurality of original frames into a synchronous frame and an asynchronous frame; deciding a position of a pixel block in which the watermark that becomes different every frame depending on a secret key, is being embedded; performing a DCT with respect to the pixel block; performing the quantization with respect to the pixel block; embedding a strong watermark in the synchronous frame as a synchronous signal; and embedding a weak watermark in the asynchronous frame.

Also, the step of performing the quantization comprises the steps of: obtaining a low-bound value so as to remove an interference phenomenon between a host signal of the frame and a watermark signal to be embedded; and quantizing the host signal using the low-bound value.

Further, the low-bound value is obtained by a following equation:

$$low - bound = floor ( \frac{{v}_{a c}}{Δ} ) \times Δ$$

where, floor(x) returns the largest integer among integers less than the x, ν_{ac} is a DCT coefficient of the frame, and Δ is a quantization step size.

Furthermore, the step of quantizing the host signal comprises obtaining a quantized value, and the quantized value is calculated by a following equation:

$${v}_{m} = low - bound + \frac{Δ}{2}$$

where, νₘ is the quantized value, and Δ is the quantization step size.

Moreover, the step of embedding the watermark is performed by a following equation:

ν′={νₘ+Δ/4, if the watermark is 1}

ν′={νₘ−Δ/4, if the watermark is 0}

where, νₘ is the quantized value, and Δ is the quantization step size.

In accordance with another aspect of the present invention, there is provided a real-time blind watermarking method using a quantization in extracting a watermark from a digital data including an image in which a digital watermark is embedded. The method comprises the steps of: extracting the watermark from an input frame and determining whether or not the input frame is a synchronous frame; if the input frame is not the synchronous frame, inspecting a next frame to search the synchronous frame; and if the synchronous frame is found, extracting the watermark in a unit of GOW from the next frame.

Also, the step of determining whether or not the input frame is the synchronous frame determines the input frame as the synchronous frame if the input frame contains a synchronous signal, and determines the input frame as an asynchronous frame if the input frame does not contain the synchronous signal.

Further, the step of extracting the embedded watermark is performed by a following equation:

wₑ={1, if (νᵣ−νₘ)>0}

wₑ={0, if (νᵣ−νₘ)<0}

where, wₑ is the extracted watermark, and vᵣ is a signal for extracting the watermark.

Furthermore, the step of determining whether the extracted bitstream contains watermark or not is performed by a following equation, i.e, if S is bigger than certain threshold value we determine that the watermark is embedded, and if not watermark is not embedded.

S=Σsₗ

where, sₗ is 1 if a bit of the input watermark equals to a bit of the extracted watermark, sᵢ is 0 if the bit of the input watermark differs from the bit of the extracted watermark, and S is a similarity value and is a bit number of a correctly extracted watermark.

### BRIEF DESCRIPTION OF THE DRAWINGS

The above object, other features and advantages of the present invention will become more apparent by describing the preferred embodiment thereof with reference to the accompanying drawings, in which:

FIG. 1 is a block diagram of an apparatus for carrying out a watermarking method in accordance with an embodiment of the invention;

FIG. 2 is a schematic view for illustrating the conventional PAM way and a center movement way in accordance with the present invention;

FIG. 3 is a schematic view showing a method for repeatedly extracting a synchronous signal in accordance with the present invention;

FIG. 4 is a schematic view showing a synchronous frame and an asynchronous frame in accordance with the present invention;

FIG. 5 is a flow chart for illustrating a procedure for embedding a watermark in a digital data in accordance with the present invention; and

FIG. 6 is a flow chart for illustrating a procedure for extracting an embedded watermark in accordance with the present invention.

### DETAILED DESCRIPTION OF THE PREFERRED EMBODIMENT

Hereinafter, preferred embodiments of the present invention are described in detail with reference to the accompanying drawings.

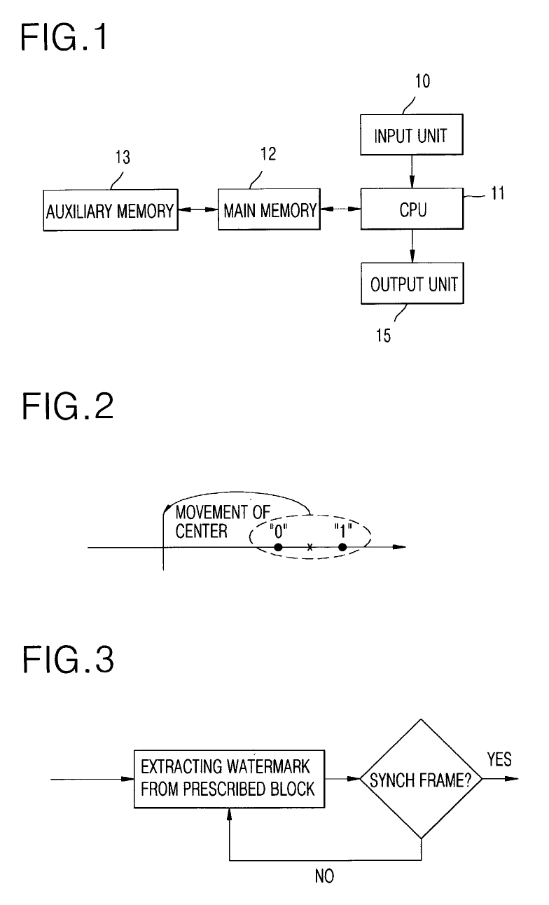

FIG. 1 is a block diagram of a terminal apparatus for carrying out a watermarking method in accordance with an embodiment of the invention.

Referring to FIG. 1, the terminal apparatus includes a central processing unit (CPU) 11, a main memory 12 connected to the CPU 11, an auxiliary memory 13 connected to the main memory 12, an input unit 10 and an output unit 15 connected to the CPU 11.

Here, the CPU 11 controls and manages an overall operation of the terminal. The main memory 12 and the auxiliary memory 13 store a program executed in the CPU 11, and various kinds of data used or generated during carrying out works. The input unit 10 and the output unit 15 are used for input and output of data from a user.

The auxiliary memory 13 stores massive data. The input unit 10 is comprised of a user interaction supporting input unit, such as a general keyboard, a mouse, a tablet, a touch screen or the like, and the output unit 15 is comprised of a display, a printer, a video recorder, etc.

First, describing the creation and embedment of a watermark representing copyrights of digital data, the watermark can be made in two ways by a combination of “0” and “1”.

In other words, through a random number generator, an arbitrary bit column including “0” and “1” is made, and it can be used as the watermark signal. Also, a signal having a meaning, such as image, audio or the like is made in a bit column including “0” and “1”, and the bit column can be embedded as the watermark signal.

The present invention embeds the watermark using the 2-ary PAM (Pulse Amplitude Modulation) method. As generally known, in order to bestow the robustness upon the watermark, the watermark is embedded in the frequency domain using a cosine transform.

Differently from the Fourier transform, DCT (Discrete Cosine Transform) results in a real number (one-dimensional signal). Other methods except for the PAM request two or more dimensional signal, but the PAM requests only one-dimensional signal.

If the watermark is embedded in the Fourier transform domain, other methods, for instance, QAM, PSK, etc., can be also used.

In the conventional digital telecommunication method (PAM), “0” and “1” are transmitted to a reference signal (zero energy) according to information. In order to restore the transmitted information, it is necessary to compute whether the received signal is greater or less than zero, and also to extract the information.

In other words, by removing only the reference signal from the received signal, the conventional method can be used without a change. Accordingly, as will be seen in FIG. 2, it is simply necessary to move a central portion indicated by the symbol “x” to zero. In other words, it is necessary to remove the “x” from the watermarked signal. For this purpose, it is necessary to know the “x” from the watermarked signal. In the blind method that cannot use the original signal, since it is impossible to directly know the “x”, the present invention utilizes a transformed original signal. For the “x” used in the invention, a recognizable value in both of the host signal and the watermarked signal, i.e., a quantized value is used.

The present invention embeds the watermark divided into a synchronous frame and an asynchronous frame in order to cope with a time-axial attach that is the representative example of the video edit. A strong watermark is embedded in the synchronous frame, and a weak watermark is embedded in the asynchronous frame. The strongly embedded signal is the synchronous signal.

The synchronous frame is very important in the present invention. In the watermarking algorithm in which existence or non-existence of the watermark is confirmed based on the similarity, synchronous information is very important. However, the time-axial edit causes the synchronous information to be lost, so that it becomes impossible to confirm existence or non-existence of the watermark. To this end, the invention embeds the synchronous signal using the following method.

A strong watermark is embedded at a prescribed position of a start frame. This strong watermark as embedded is just the synchronous signal, and the synchronous signal is always embedded in a unit of 100 frames (GOW: Group of Watermark). If the synchronous signal is embedded, real watermark information (weak watermark: is weak in the intensity compared with the synchronous signal) is embedded from the next frame until the next synchronous signal (strong watermark) is embedded. Since the synchronous signal is very important, it is strongly embedded.

After the watermark is embedded like the above, the watermark is extracted from a prescribed block of the start frame. If the watermark is the synchronous signal, the watermark is extracted from the next frame, and the similarity is calculated in the unit of GOW to thereby determine existence or non-existence of the watermark. If the information extracted from the start frame is not the synchronous signal, the watermark is extracted from the next frame, and the computation is performed in order to determine whether or not the extracted watermark is the synchronous information. This procedure continues until the synchronous information is extracted. By performing the aforementioned method, it becomes possible to make a watermarking algorithm that is robust against the time-axial edit applied to the video.

An arbitrary block for embedding the watermark with respect to an input frame is decided by a secret key created from the random number generator using the seed, which corresponds that two-dimensional DCT is carried out with respect to a corresponding 8×8 pixels block.

In the present invention, the watermark is embedded not in all frames, but only in an arbitrary block decided by the secret key.

If the watermark is embedded in all blocks, and is subject to multiple attacks, it is weakened. If another watermark is embedded in a watermarked signal, a previously embedded relationship disappears and thus it becomes impossible to extracted the initially embedded watermark. To this end, the watermarks are embedded in different blocks from each other every frame depending on arbitrary positions generated by the random number generator. As a consequence, the watermark is extracted from a block different from the block of the initially embedded watermark.

Further, if the watermark is embedded in an arbitrary block, it is possible to enhance the picture quality of the watermarked signal. According to visual characteristic of human being, when the watermark is embedded in the same position every frame, degeneration in the picture quality appears, but when the watermark is embedded in different positions every frame, the degeneration in the picture quality is felt relatively small.

In the meanwhile, if it is possible to obtain an unchanged value before and after the insertion of the watermark, it is possible to decrease interference between the host signal and the watermark signal by removing this unchanged value. In order to remove the host signal, low-bound of DCT coefficient is calculated.

The low-bound is obtained by the following equation 1:

$$low - bound = floor ( \frac{{v}_{a c}}{Δ} ) \times Δ , \qquad Equation 2$$

where, Δ is a value related with the embedding intensity of the watermark, and is also related with the quantization level. Floor(x) returns the largest integer among integers less than the x, ν_{ac} is a DCT coefficient of the original signal, and Δ is a kind of quantization step size. As the value of Δ increases, the watermark is more strongly embedded. Thus, if the low-bound is obtained, νₘ that is a transformed original signal is calculated. In other words, the value of νₘ is the original signal used in extracting the watermark later.

By removing the value of νₘ upon extracting the watermark, it is possible to reduce interference between the host signal and the watermark signal.

For the quantization of the host signal, there is need to obtain a quantized value, and the quantized value is calculated by the following equation 2:

$${v}_{m} = low - bound + \frac{Δ}{2} , \qquad Equation 2$$

where, νₘ is the portion indicated by the symbol “x”. Hereinafter, the center-moved and transferred νₘ is regarded as the original signal. Upon extracting the watermark, interference phenomenon can be removed by calculating the νₘ and removing the calculated νₘ.

The embedding of the watermark is carried out by the following equation 3:

ν′={νₘ+Δ/4, if the watermark is 1}

ν′={νₘ−Δ/4, if the watermark is 0} Equation 3,

where, ν′ indicates a coefficient in which the watermark is embedded.

In the meanwhile, the extracting procedure of the watermark embedded in the frame is similar to the embedding procedure of the watermark, and is described hereinafter.

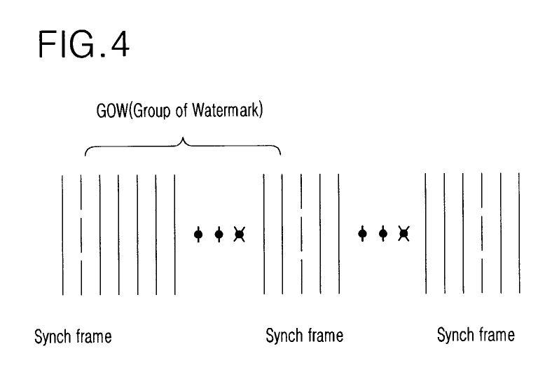

In order for the watermark to be robust against the time-axial edit, the synchronous frame was embedded. So, the synchronous frame in which the synchronous signal is embedded should be detected. After the watermark is extracted from a prescribed position of the start frame, it is compared whether or not the extracted watermark value is the synchronous signal. If the extracted watermark value is the synchronous signal, a next step of extracting a weak watermark (real-embedded watermark information) is carried out. If the extracted watermark value is not the synchronous signal, the watermark is extracted from a prescribed block of a next frame, and it is compared whether or not the extracted watermark is the synchronous signal. This procedure continues until a synchronous frame is detected. Such a circulation procedure is shown in FIG. 3. In other words, on the whole, the watermark and the synchronous information are embedded as shown in FIG. 4.

Also, the synchronous frame is input in a period of 100 frames.

In the extraction of the watermark, the synchronous signal is extracted, the watermark information is extracted, and then the similarity is measured. In order to extract the watermark, the low-bound is calculated using the equation 1. For the computation of the low-bound, the DCT coefficient of a signal in which the watermark is embedded is utilized instead of ν_{ac}, and νₘ is calculated using the equation 2.

The watermark is extracted using the following equation 4:

wₑ={1, if (νᵣ−νₘ)>0}

wₑ={0, if (νᵣ−νₘ)<0} Equation 4,

where, wₑ represents the extracted watermark, and vᵣ represents a received signal. The received signal νᵣ may or may not have the watermark, and be subject to various signal processing. Removing νₘ from the above equation 4 represents the movement procedure of the center shown in FIG. 2.

By utilizing a modified host signal, not the host signal, it is possible to extract the watermark information in the blind method. Also, by removing the modified original signal νₘ from the watermarked signal νᵣ, it is possible to reduce interference phenomenon.

In the meanwhile, after the synchronous signal is detected, the weak watermark is extracted in the unit of GOW, and then the similarity between the embedded watermark and the extracted watermark is calculated, thereby determining whether the watermark is embedded or not. The determining is performed by the following equation 5:

S=Σsᵢ

where, sᵢ is 1 if the bit of the embedded watermark equals to the bit of the extracted watermark, and sᵢ is 0 if the bit of the embedded watermark differs from the bit of the extracted watermark. Accordingly, this similarity value (S) represents a bit number of a correctly extracted watermark.

Next, there is described a method for embedding a watermark in order to protect copyrights of digital data such as video or the like in accordance with one embodiment of the invention.

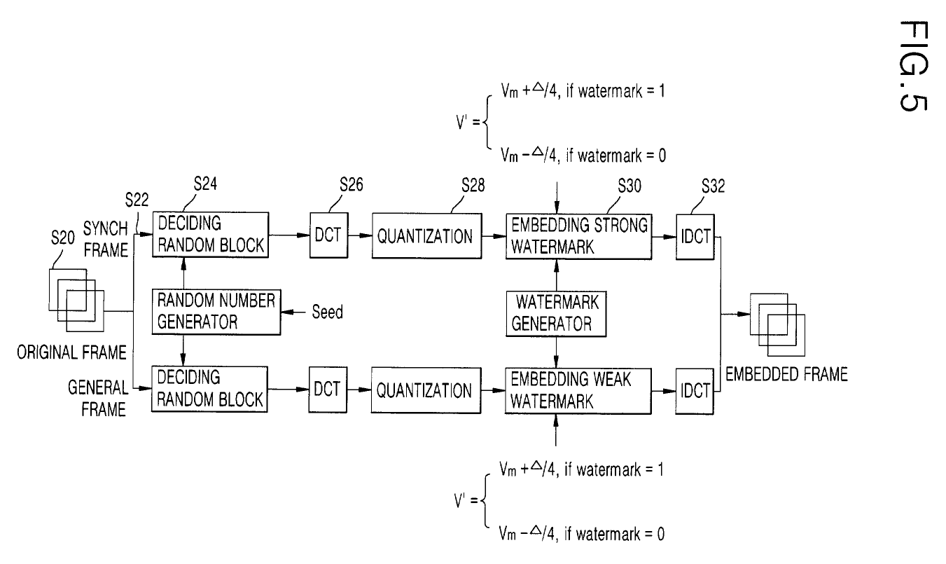

FIG. 5 illustrates a flow chart for embedding the watermark in accordance with the invention.

Since the invention uses a method based on the similarity upon proving existence or non-existence of the watermark, synchronous information of the watermark is very important. Further, since the video signal needs frequent edit with respect to the time axis, there should be preparation for the time axial edit. For this purpose, the invention makes the synchronous frame, extracts the watermark since the generation of the synchronous frame, and measures the similarity. Since the synchronous frame watermark information should be always extracted, it is more strongly embedded than other watermarks.

Next, there is described a method for embedding the watermark.

In the steps of S20 and S22, a plurality of original frames are divided into the synchronous frame and the asynchronous frame.

First, there is described a method for embedding the watermark in the synchronous frame. A seed is inputted into the random number generator, thereby obtaining an arbitrary progression. This arbitrary progression decides a position of an 8×8 pixels block for embedding the watermark, in which the pixels blocks are chosen to have different positions every frame. (S24)

If an 8×8 pixels block of the asynchronous frame is chosen by a secret key (seed), DCT is performed with respect to the corresponding 8×8 pixels block. Two-dimensional forward directional DCT is performed with respect to the 8×8 pixels block to thereby quantize a low frequency component. The quantizing procedure consists of the equation 1 and the equation 2. The equation 1 is to obtain a boundary value of the quantization, and the equation 2 is to obtain a quantized value using the low-bound boundary value. (S26 and S28) At this time, used quantization step size is a relatively small value.

Afterwards, the watermark is embedded according to the aforementioned equation 3, a reverse directional two-dimensional DCT is performed, and is substituted for the original frame, thereby completing the embedding procedure of the watermark. (S30 and S32)

Meanwhile, the embedding procedure of the watermark with respect to the synchronous frame corresponds with that with respect to the asynchronous frame except for two items. First, the position for embedding the watermark in the synchronous frame is designated in advance. Further, in order to embed a strong watermark, a relatively large quantization step is utilized.

Meanwhile, the difference between the strong watermark and the weak watermark is the difference between the quantization step sizes Δ, and as the quantization step size increases, a stronger watermark is created.

As described above, according to the method for embedding the watermark used for protecting the copyright, a plurality of frames are divided into the synchronous frame and the asynchronous frame.

Next, the position of 8×8 pixels block is arbitrarily set every frame by a secret key, and DCT is performed with respect to the corresponding pixels block, thereby quantizing the corresponding pixels block.

Strong watermark is embedded in the synchronous frame and weak watermark is embedded in the asynchronous frame. The strong watermark that is the synchronous signal is always embedded in a period of 100 frames, and is used upon extracting the watermark.

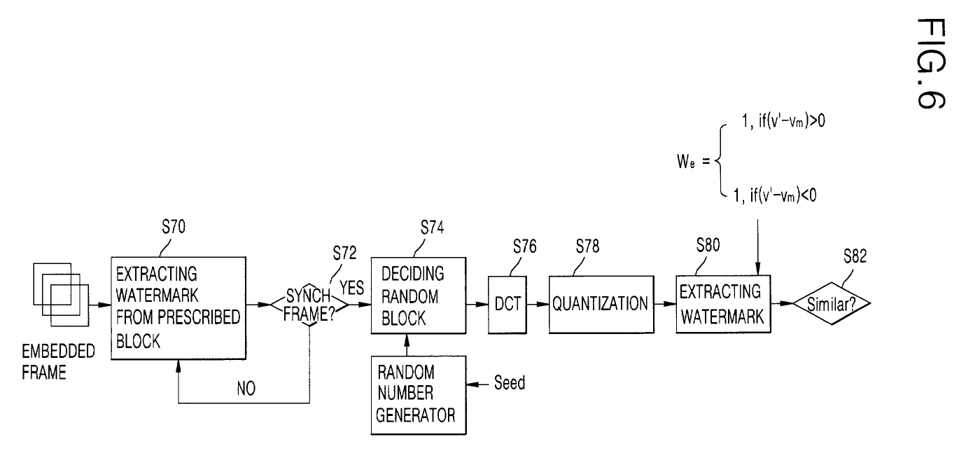

Meanwhile, FIG. 6 is a flow chart for illustrating a procedure for embedding the watermark and determining whether the extracted watermark is true or false.

The watermark is extracted from a block arranged at a fixed position of a frame in which the watermark is embedded. (S70) It is compared whether or not the signal extracted in the step of S70 is the synchronous signal until the synchronous frame is found. (S72)

If the synchronous frame is detected, a real-embedded watermark is extracted from the next frame. In other words, a watermark contained in an asynchronous frame arranged next to the detected synchronous frame is extracted.

Using a random number generator, an arbitrary progression, which was used in embedding the watermark is generated, and a position of an 8×8 pixels block in which the watermark is embedded is searched. (S74)

Thereafter, two-dimensional forward directional DCT is performed with respect to the corresponding 8×8 pixels block, movement of the center is performed similarly to that of when embedding the watermark, and then the embedded watermark is extracted using the equation 4. (S76, S78 and S80)

The similarity of the extracted watermark is calculated every 100 frames that is a unit of GOW, thereby confirming existence or non-existence of the watermark.

The similarity of the extracted watermark is calculated using the equation 5. If the bit of the embedded watermark is identical to the bit of the extracted watermark, it is counted “1”, and if the bit of the embedded watermark differs from the bit of the extracted watermark, it is counted “0”. Accordingly, the similarity value of the equation 5 represents a bit number of a watermark that is correctly extracted. (S82)

As described previously, the blind watermarking algorithm is the most important portion in realizing a real-time video watermarking system. The invention assumes a quantized signal as an original signal and applies the watermark embedding and extracting algorithm. Upon extracting the watermark, the quantized signal assumed as the original signal is calculated and the calculated signal is removed from the watermarked signal, thereby removing interference phenomenon between the host signal and the watermark signal. Further, the invention has an advantage in which all digital telecommunications methods can be used.

Furthermore, the invention enables to embed or extract the watermark at a constant rate regardless of the size of the original video signal. This is because a frame is divided into 8×8 pixels blocks and the watermark is embedded in the blocks of a fixed number. Moreover, the synchronous information is embedded in the synchronous frame in order for the watermark to be robust against the video edit that is the time-axial edit. This synchronous information is very important in the watermarking algorithm based on correlation. Accordingly, this information should be extracted, which is a kind of public watermark format, can be extracted by anybody the information, and is strongly embedded.

As a result, use of the invention provides an effect in which a robust real-time video watermarking system enabling to confirm the copyrights of digital data is realized in spite of various attacks such as the time-axial attack or the like.

Although the preferred embodiments of the present invention have been disclosed for illustrative purposes, those skilled in the art will appreciate that various modifications, additions and substitutions can be made without departing from the scope and spirit of the invention as defined in the accompanying claims.

What is claimed is:

1. A real-time blind watermarking method using a quantization in embedding a watermark for protecting a copyright of a digital data including an image or a video, the method comprising the steps of:
dividing a plurality of original frames into a synchronous frame and an asynchronous frame;
deciding a position of a pixel block in which the watermark that becomes different every frame depending on a secret key, is being embedded;
performing a DCT with respect to the pixel block;
performing a quantization with respect to the pixel block;
embedding a strong watermark in the synchronous frame as a synchronous signal; and
embedding a weak watermark in the asynchronous frame.

2. The method of claim 1, wherein the step of deciding the position of the pixel block inserts the watermarks at different positions every frame in order to decrease degeneration of the video as the digital data and enable to insert a multiple-watermark.

3. The method of claim 1, wherein the step of performing the quantization comprises the steps of:
obtaining a low-bound value so as to remove an interference phenomenon between a host signal of the frame and a watermark signal to be embedded; and
quantizing the host signal using the low-bound value.

4. The method of claim 3, wherein the low-bound value is obtained by a following equation:
$$low - bound = floor ( \frac{{v}_{a c}}{Δ} ) \times Δ$$
where, floor(x) returns the largest integer among integers less than the x, ν_{ac} is a DCT coefficient of the frame, and Δ is a quantization step size.

5. The method of claim 3, wherein the step of quantizing the host signal comprises obtaining a quantized value, and the quantized value is calculated by a following equation:
$${v}_{m} = low - bound + \frac{Δ}{2}$$
where, νₘ is the quantized value, and Δ is the quantization step size.

6. The method of claim 1, wherein the step of embedding the watermark is performed by a following equation:
ν′{νₘ+Δ/4, if the watermark is 1}
ν′{νₘ−Δ/4, if the watermark is 0}
where, νₘ is the quantized value, and Δ is the quantization step size.

7. The method of claim 1, wherein the strong watermark and the weak watermark are due to a difference between the quantization step sizes, and the larger the quantization step size is, the stronger the watermark is.

8. A real-time blind watermarking method using a quantization in extracting a watermark from a digital data including an image in which a digital watermark is embedded, the method comprising the steps of
extracting the watermark from an input frame and determining whether or not the input frame is a synchronous frame;
if the input frame is not the synchronous frame, inspecting a next frame to search the synchronous frame; and
if the synchronous frame is found, extracting the watermark in a unit of GOW from the next frame.

9. The method of claim 8, wherein the step of determining whether or not the input frame is the synchronous frame determines the input frame as the synchronous frame if the input frame contains a synchronous signal, and determines the input frame as an asynchronous frame if the input frame does not contain the synchronous signal.

10. The method of claim 8, wherein the step of extracting the watermark comprises the steps of:
searching for a position where the watermark is embedded into the frame;
performing a DCT at the position where the watermark is embedded;
executing a quantization after performing the DCT;
extracting the embedded watermark; and
determining whether the extracted watermark is true or false by comparing the extracted watermark with an input watermark.

11. The method of claim 10, wherein the step of extracting the embedded watermark is performed by a following equation:
wₑ={1, if (νᵣ−νₘ)>0}
wₑ={0, if (νᵣ−νₘ)<0}
where, wₑ is the extracted watermark, and vᵣ is a signal for extracting the watermark.

12. The method of claim 9, wherein the step of determining whether the extracted bitstream contains watermark information or not is performed by a following equation:
S=Σsₗ
where, sₗ is 1 if a bit of the input watermark equals to a bit of the extracted watermark, sᵢ is 0 if the bit of the input watermark differs from the bit of the extracted watermark, and S is a similarity value and is a bit number of a correctly extracted watermark.
